(19) United States
(12) Patent Application Publication
(10) Pub. No.: US 2007/0234862 A1
(43) Pub. Date: Oct. 11, 2007

(54) Method and Apparatus for Fray-Free Cutting with Laser Anti-Fray Inducement

(75) Inventor: Steen B. Mikkelsen, Fontana, WI (US)

Correspondence Address: JANSSON SHUPE & MUNGER LTD., 245 MAIN STREET, RACINE, WI, 53403, US

(73) Assignee: MIKKELSEN GRAPHIC ENGINEERING, INC., Lake Geneva, WI (US)

(21) Appl. No.: 11/697,051

(22) Filed: Apr. 5, 2007

Related U.S. Application Data
(63) Continuation-in-part of application No. 11/398,335, filed on Apr. 5, 2006.

(51) Int. Cl. B26D 7/06; B26D 1/00

(52) U.S. Cl. 83/32; 83/438

(57) ABSTRACT

A method and apparatus for fray-free cutting at the perimeter of an area of a textile sheet on a textile-receiving surface, including creating an anti-fray condition in the sheet along a path at the perimeter by an anti-fray instrument movable along the surface as directed by a controller based on programmed information regarding the perimeter, and cutting the sheet at the perimeter by a cutter movable along the surface as directed by the controller based on the programmed information. The anti-fray instrument is preferably an anti-fray substance applicator or, if the textile is a thermoplastic textile, a laser device configured and arranged to induce an anti-fray state therein.

### RELATED APPLICATION

This application is a continuation-in-part of patent application Ser. No. 11/398,335, filed Apr. 5, 2006, currently pending. The contents of the parent application are hereby incorporated by reference.

### FIELD OF THE INVENTION

The invention is related generally to the field of textile processing technology and more particularly to fray-free cutting of textiles or the like for various purposes.

### BACKGROUND OF THE INVENTION

Many textile materials of woven or non-woven nature tend to fray when cut into pieces or shapes and subsequently handled during various operations. It is highly desirable that the cutting of textiles be carried out in a manner preserving the cut edges from fraying or other similar degradation. Indeed, advantages of precision cutting tend to be lost due to fraying and other edge-related concerns.

The prior art includes a number of disclosures of applying liquid polymeric materials for purposes of avoiding textile fraying, or for piece-to-piece bonding purposes in which anti-fray capabilities of bonding agents are noted. Pertinent documents include U.S. Pat. No. 6,630,043 (Sloot), U.S. Pat. No. 5,601,132 (Goodman), U.S. Pat. No. 5,783,623 (Skoufis), U.S. Pat. No. 5,981,034 (Gray et al.), U.S. Pat. No. 5,718,966 (Gray et al.), U.S. Pat. No. 5,538,280 (Gray et al.), U.S. Pat. No. 5,085,917 (Hodnett) and U.S. Pat. No. 4,261,285 (Pearl), and United States Published Patent Applications 2005/0170151 (Dobson et al.) and 2002/0017362 (Covert et al.).

There remains a need for improved high-precision cutting apparatus and methods with textile-preserving anti-fray edge protection.

### OBJECTS OF THE INVENTION

It is an object of the invention to provide fray-free cutting overcoming some of the problems and shortcomings of the prior art, including those referred to above.

Another object of the invention is to provide an anti-fray protection along and about the perimeter of a certain area to be cut out of a textile sheet.

Another object of the invention is to provide an anti-fray protection for the textile sheet by utilizing high-precision technology for creating an anti-fray condition on the sheet.

Still another object of the invention is to provide anti-fray cutting apparatus and method which precisely creates an anti-fray condition on the sheet to achieve the desired protection.

How these and other objects are accomplished will become apparent from the following descriptions and the drawings.

### SUMMARY OF THE INVENTION

The present invention provides an improved apparatus and method for fray-free cutting at the perimeter of areas of textile sheets (printed or unprinted) for which particularly accurate cutting is required.

The apparatus includes a textile-receiving surface, a controller having programmed information regarding the perimeter of the area, a cutter movable with respect to the surface as directed by the controller to cut the sheet at the perimeter of the area, and an anti-fray instrument movable with respect to the surface as directed by the controller based on the programmed information to form an anti-fray path along the perimeter.

The inventive apparatus preferably includes support structure secured with respect to the textile-receiving surface, with the anti-fray instrument being attached to the support structure for controlled movement along the textile-receiving surface. The textile-receiving surface is preferably substantially horizontal. The inventive apparatus may further include a vacuum structure adapted to retain the textile sheet in position on the textile-receiving surface.

In highly preferred embodiments, the support structure includes a support beam spanning the textile-receiving surface and reversibly movable therealong, and the anti-fray instrument is reversibly movable along the beam. In some preferred embodiments the cutter is also attached to such beam and is reversibly movable therealong. The anti-fray instrument and the cutter are preferably movable both with the beam (i.e., movement in the X-direction) and with respect to (along) the beam (i.e., movement in the Y-direction) in a manner providing independent concurrent movement thereof In certain highly preferred embodiments of this type, for perimeter lines extending parallel to the direction of beam movement the controller is further programmed for concurrent creation of the anti-fray condition in the sheet by the anti-fray instrument and cutting by the cutter with the anti-fray instrument and the cutter in the same Y-position along the beam, thereby to increase productivity.

In a variant of embodiments involving concurrent creation of the anti-fray condition in the sheet and cutting, the beam may include a main portion and an arm movably projecting from the main portion with the anti-fray instrument being disposed on the arm. In such variant the arm may have a telescopic configuration for moving the anti-fray instrument in a direction perpendicular to the beam.

In some embodiments involving a single support beam, the anti-fray instrument and the cutter may be interchangeably attached to the beam such that the step of creating the anti-fray condition and the cutting step require mounting of the appropriate device to the beam.

In some preferred embodiments a second support beam spans the textile-receiving surface and is reversibly movable therealong independently of the other beam, the cutter being secured to and reversibly movable along the second beam, while the anti-fray instrument is secured to and reversibly movable along the first beam.

One important aspect of this invention is that the programmed information includes information regarding specific graphic characteristics of the textile sheet and information regarding the perimeter of the area relative thereto. In such situations the apparatus further includes a sensor positioned to sense the specific (graphic or other) characteristics of the textile sheet, and the controller is configured to utilize sensed information and the programmed information to compensate for deviations sensed from the programmed information of the specific graphic characteristics. Most preferably, the specific graphic characteristics and the controller programming are such that the controller compensates for non-uniform distortions of the textile sheet.

In the present invention, the specific graphic characteristics may include registration marks at and/or around the perimeters of printed graphics on and to be cut from the textile material, the registration marks having been applied during the printing of graphics thereon. In some cases, however, the textiles will not include graphics or even registration marks thereon, and the information to be sensed may be sheet edges and/or other characteristics.

Various embodiment of the apparatus of this invention, particularly as it relates to the nature and operation of the aforesaid anti-fray instrument, will be referrer to below, after a brief summary of the inventive method.

The inventive method includes: creating an anti-fray condition in the sheet along a path at the perimeter by operation of an anti-fray instrument movable along the surface as directed by a controller based on programmed information regarding the perimeter, and cutting the sheet at the perimeter by a cutter movable along the surface as directed by the controller based on the programmed information.

In preferred embodiments of the method of this invention, the step of creating the anti-fray condition is prior to the cutting step. In certain preferred examples of the method of this invention the cutting of the sheet commences while the step of creating the anti-fray condition is still in progress.

The preferred examples of the method include steps of automatically sensing the specific graphic characteristics, and utilization by the controller of sensed information and the programmed information to compensate for deviations sensed from the programmed information of the specific graphic characteristics. In some of such examples the specific graphic characteristics and the controller programming are such that the controller compensates for non-uniform distortions of the textile sheet.

In certain highly preferred embodiments of the apparatus of the present invention, the anti-fray instrument is an anti-fray substance applicator movable with respect to the surface as directed by the controller based on the programmed information to form an anti-fray path along the perimeter.

The anti-fray substance is preferably a liquid, with the applicator being a liquid-dispensing device. In certain embodiments the liquid-dispensing device is a liquid jet. In other embodiments the liquid-dispensing devices are airbrushes or rollers for contact with the textile sheet.

The anti-fray liquid is preferably applied prior to the cutting. However, in some situations applying and cutting can be carried out essentially at the same time, an example of which is mentioned below. In some situations the applying step can occur immediately after the cutting step, rather than before or at the same time.

The anti-fray substance preferably sets after penetration into the textile sheet. Most preferably, the liquid-dispensing device is adapted for dispensing the liquid to penetrate less than the full thickness of the textile sheet, whereby, after dispensing, the liquid does not reach the textile-receiving surface.

It is highly preferred that the liquid be a quick-setting liquid which, when set in the textile sheet, is also substantially transparent and non-glossy. The liquid is preferably a hotmelt composition selected to accommodate the nature of the textile material being cut and other specific requirements such as selected speeds, etc.

The liquid-dispensing device is preferably configured and arranged such that the path of applied liquid is no more than about 5 mm in width. The width of the path can be as narrow as the accuracy of the cutting control system allows. It is desirable to minimize path-width in order to minimize or even avoid any visual impact the presence of such path might have in finished goods.

In certain embodiments the position of the liquid-dispensing device is controlled such that the opposite edges of the path of applied liquid are preferably on opposite sides of the perimeter. The liquid-dispensing device position may be controlled such that the opposite edges of the path of applied substance are substantially parallel to and substantially equally spaced from the perimeter. In alternative embodiments the liquid-dispensing device position is controlled such that the path of applied liquid is inside the area and closely adjacent to the perimeter.

In certain embodiments of the invention the applicator is a preformed-strip dispenser, and the anti-fray substance is a preformed strip of textile-adherent material. The preformed-strip dispenser includes a carrier web from which the preformed strip is released when it adheres to the textile sheet.

In certain highly preferred embodiments of the method of the present invention, the creating of an anti-fray condition is by applying an anti-fray substance onto the sheet along the path.

In highly preferred examples of such embodiments, the applying step is prior to the cutting step. In certain cases of such examples the cutting of the sheet commences while the applying step is still in progress on the sheet.

The preferred examples of the method include steps of automatically sensing the specific graphic characteristics, and utilization by the controller of sensed information and the programmed information to compensate for deviations sensed from the programmed information of the specific graphic characteristics. In some of such examples the specific graphic characteristics and the controller programming are such that the controller compensates for non-uniform distortions of the textile sheet.

In certain alternative embodiments of the apparatus of this invention, the textile sheet is a thermoplastic textile sheet and the anti-fray instrument is a laser device configured and arranged to induce an anti-fray state in the textile by application of laser energy as directed by the controller based on the programmed information to form an anti-fray path along the perimeter of the area. Such laser device is preferably adapted for application of laser-energy having a focal point set to induce the anti-fray state of less than the full thickness of the textile sheet, whereby the anti-fray-induced portion of the textile does not touch the textile-receiving surface.

The laser device is preferably a solid-state laser selected to apply the desired laser energy onto the thermoplastic textile material. Alternatively, the laser device may be of the type including at least one mirror. Such device is directed by the controller based on the programmed information to direct the laser energy onto the textile to form the anti-fray path along the perimeter of the area.

The laser device may be configured and arranged to apply laser energy onto the textile along the perimeter to thereafter be cut by a blade. In different embodiments the laser device is configured and arranged to apply laser energy onto a blade-cut edge (i.e., the edge that has been cut by the blade) immediately upon or after cutting. The laser device may be carried with the cutter such that the laser device applies laser energy immediately upon cutting.

In certain highly preferred embodiments of the method of the present invention, the creating of an anti-fray condition is by inducing an anti-fray state in the textile by using a laser device to apply laser energy along the perimeter of the area.

The inducing step is such that the application of the laser-energy has a focal point set to induce the anti-fray state of the less than the full thickness of the textile sheet. After inducement, the anti-fray induced portion of the textile does not touch the textile-receiving surface.

In certain preferred examples of the embodiments of the inventive method, the inducing step is prior to the cutting step. In certain preferred examples of the method the cutting of the sheet commences while the inducing step is still in progress on the sheet. In different embodiments the laser device is configured and arranged to apply laser energy onto a blade-cut edge immediately upon or after cutting. The laser device may be carried with the cutter such that the laser device applies laser energy immediately upon cutting.

The term “textile” as used herein means any kind of woven and non-woven cloth-like material, i.e., materials made by weaving, knitting or felting, etc. Such materials may be of natural, synthetic fibers or combination of both. This includes woven KEVLAR® fibers, fiberglass and variety of other materials.

The term “sheet” as used herein refers to materials that are in a roll, folded or in another form used for storage or transportation.

The phrase “penetrate less than the full thickness of the textile sheet” as used herein means that the anti-fray liquid composition enters the textile sheet to a depth of less than about 90% of the textile thickness. The controller may be programmed to regulate the amount of the dispensed liquid based on the textile surface characteristics, and the viscosity and setting time of the liquid. The liquid is preferably dispensed through a flow-rate-controlling mechanism chosen according to the characteristics of the textile and the liquid. The liquid is dispensed in an amount sufficient to form the anti-fray protection of the textile while avoiding adherence of the textile to the textile-receiving surface.

The term “closely adjacent” as used herein with reference to the path of applied anti-fray substance means very close to but not abutting the perimeter of the area; e.g., there may be about 1-3 mm between the path of applied liquid and the perimeter of the area.

### BRIEF DESCRIPTION OF THE DRAWINGS

FIG. 1 is a perspective view of an apparatus employing the present invention with an anti-fray instrument attached to a beam.

FIG. 2 is a perspective view of the apparatus of FIG. 1 with a cutter attached to the beam in place of the anti-fray instrument.

FIG. 3 is a perspective view of an apparatus having a first and a second beams with the anti-fray instrument attached to the first beam and the cutter attached to the second beam.

FIG. 4 is a perspective view of an apparatus with the anti-fray instrument and the cutter both attached to the same beam.

FIG. 5 is a perspective view of such apparatus in which the anti-fray instrument is an anti-fray substance applicator in form of an airbrush.

FIG. 6 is a perspective view of such apparatus in which the cutter is a rotary-blade.

FIG. 7 is a perspective view of such apparatus in which the anti-fray instrument is an anti-fray substance applicator in form of a roller.

FIG. 8 is a perspective view of such apparatus in which the anti-fray instrument is an anti-fray substance applicator in form of a preformed-strip dispenser.

FIG. 9 is a plan view of an area on a textile sheet with an anti-fray path having its opposite edges on opposite sides of a perimeter of the area.

FIG. 10 is a plan view of an area on the textile sheet with the anti-fray path being inside the area and closely adjacent to the perimeter.

FIG. 11 is a plan view of the textile sheet showing an example where cutting is intended to occur.

FIG. 12 is a plan view of the textile sheet showing graphic characteristics including registration marks about areas where cutting is intended to occur.

FIG. 13 is a schematic illustration of the anti-fray instrument being a laser device.

FIG. 14 is a schematic cross-section of the textile sheet illustrating the step of inducing the anti-fray state in the textile by applying a laser energy onto the textile.

### DETAILED DESCRIPTION OF PREFERRED EMBODIMENTS

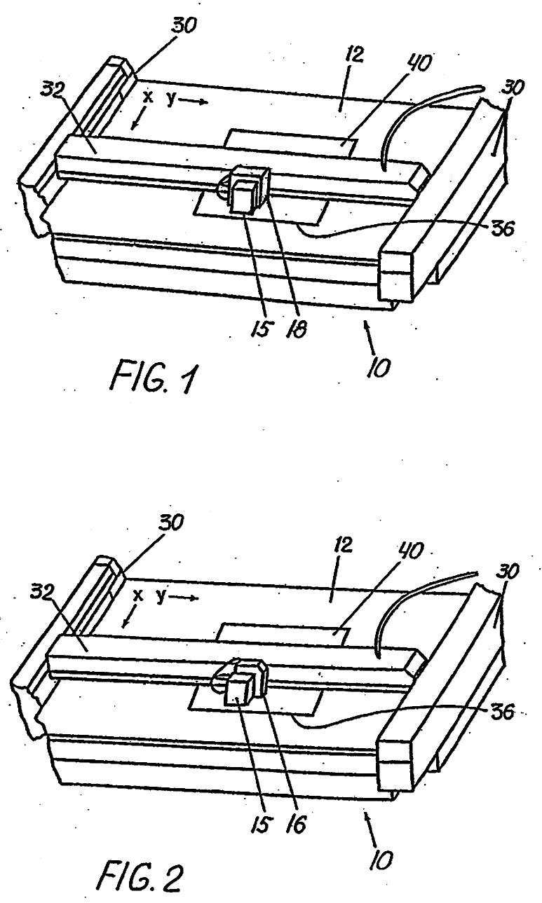

Referring to FIGS. 1 and 2, fray-free cutting apparatus 10 includes a textile-receiving surface 12, a controller 14 having programmed information regarding perimeter 44 of an area 42, a cutter 16 movable with respect to surface 12 as directed by controller 14 to cut a textile sheet 40 at perimeter 44 of area 42, and an anti-fray instrument 18 movable with respect to surface 12 as directed by controller 14 based on the programmed information to form an anti-fray path 46 along perimeter 44. Apparatus 10 may further include a vacuum structure 36 adapted to retain textile sheet 40 in position on textile-receiving surface 12.

As shown in FIGS. 1-8 the fray-free apparatuses include support structure 30 secured with respect to textile-receiving surface 12. Anti-fray instrument 18 is attached to support structure 30 for controlled movement along textile-receiving surface 12.

As best shown in FIG. 1, support structure 30 includes a beam 32 which spans textile-receiving surface 12 and is reversibly movable therealong, anti-fray instrument 18 being reversibly movable along beam 32.

In FIG. 2, cutter 16 is attached to beam 32 for reversible movement therealong in place of anti-fray instrument 18 shown in FIG. 1. Anti-fray instrument 18 and cutter 16 are interchangeable for their respective purposes.

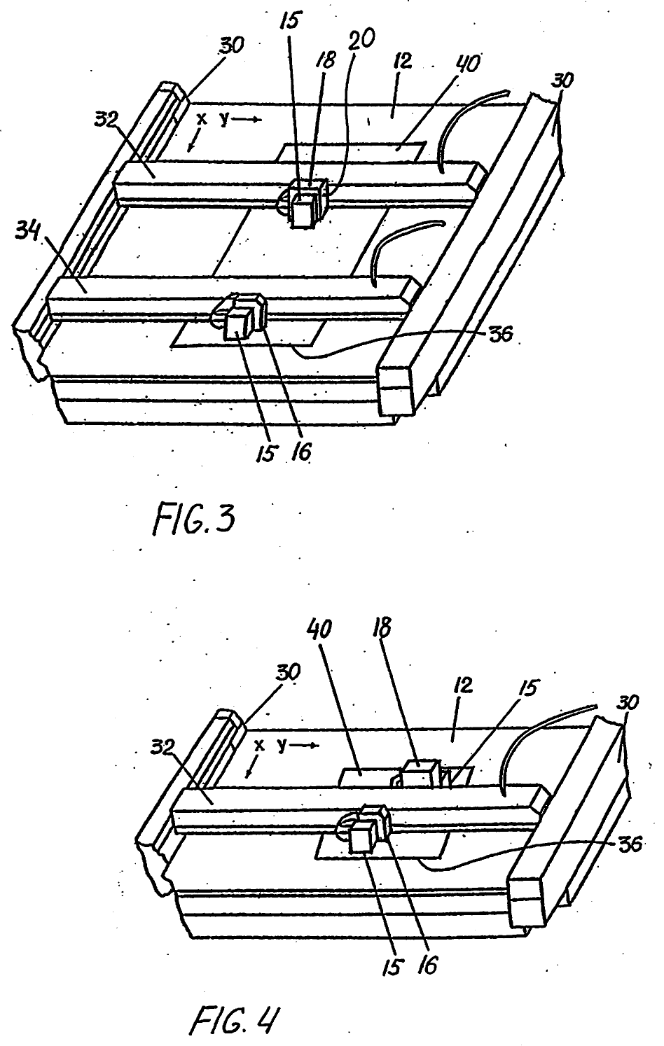

FIG. 3 shows support structure 30 with a second beam 34 spanning textile-receiving surface 12 and reversibly movable therealong independent of beam 32. Cutter 16 is reversibly movable along second beam 34.

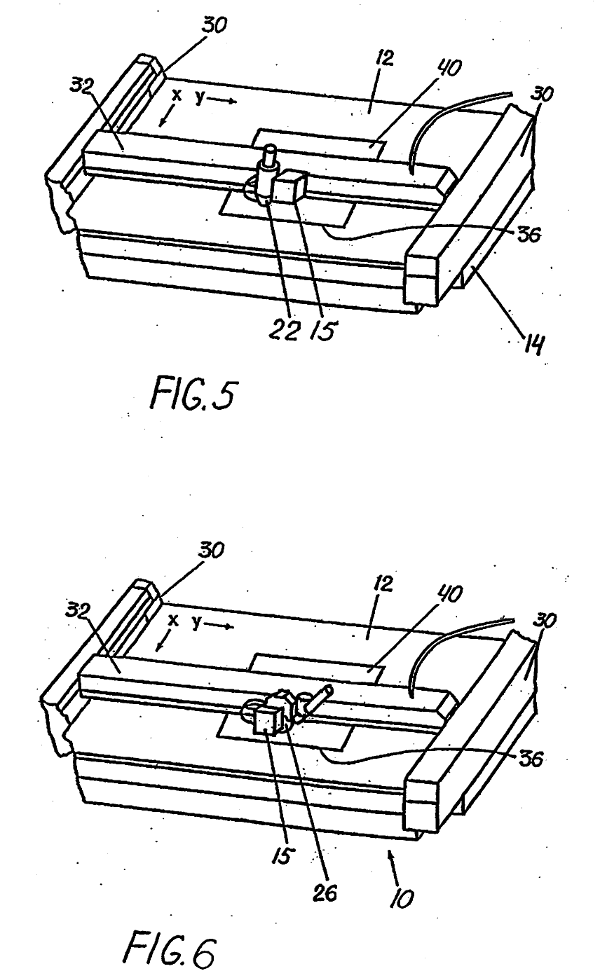

FIG. 4 shows anti-fray instrument 18 and cutter 16 both on beam 32, each being movable with and with respect to beam 32.

In certain highly preferred embodiments, the anti-fray instrument is an anti-fray substance applicator, and the anti-fray substance is a liquid. FIGS. 3 and 5-7 illustrate fray-free cutting apparatuses with the applicators being liquid-dispensing devices. FIG. 3 schematically shows liquid-dispensing device as a liquid jet 20. In FIG. 5, the liquid-dispensing device is an airbrush 22. In FIG. 7, the liquid-dispensing device is a roller 24 for contact with textile sheet 40.

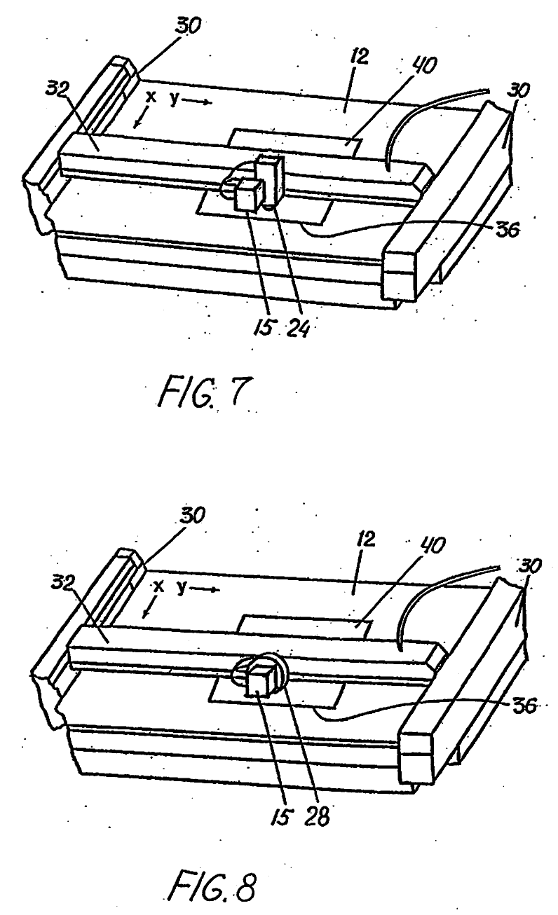

FIG. 6 illustrates a cutter which is a rotary blade 26. In certain embodiments in which the cutter is a rotary blade, the applicator may be positioned to apply a flow closely adjacent to the rotary blade such that the anti-fray substance is applied onto the sheet at the time of cutting.

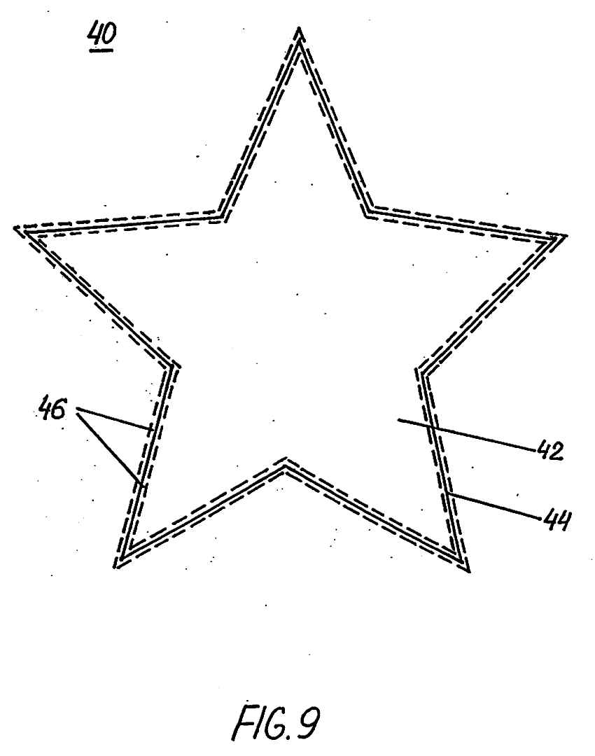

FIG. 8 shows another aspects of the present invention in which the applicator is a preformed-strip dispenser 28.

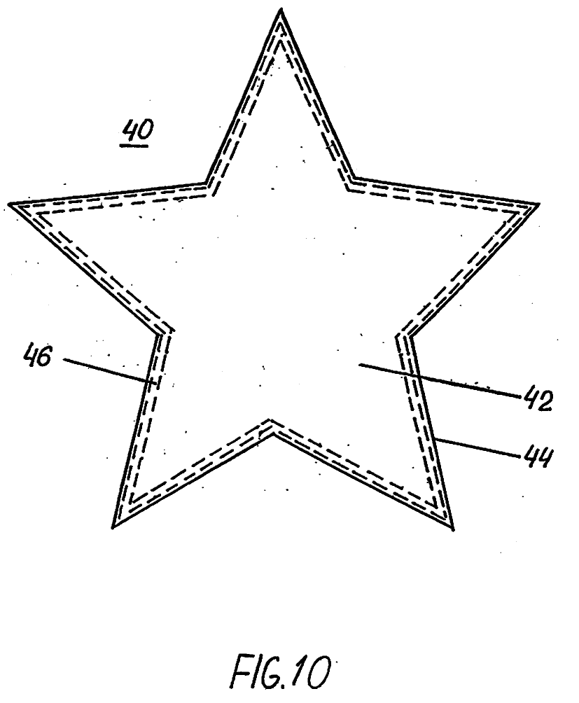

FIG. 9 illustrates a plan view of area 42 of textile sheet 40 with the opposite edges of path 46 of applied liquid are on opposite sides of perimeter 44, substantially parallel to and substantially equally spaced from perimeter 44. FIG. 10 shows path 46 of applied liquid inside area 42 and closely adjacent to perimeter 44.

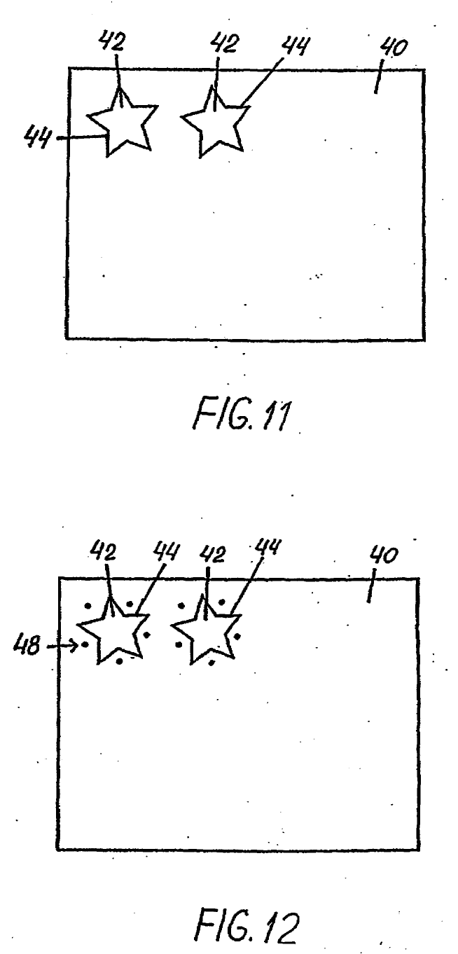

FIGS. 1-8 show a sensor 15 positioned to sense specific graphic characteristics of textile sheet 40. FIGS. 11 and 12 illustrate graphics along which cutting is intended, with FIG. 12 showing registration marks 48 at and around areas 42.

As noted above in the summary section, the anti-fray instrument in certain embodiments of this invention is a laser device. FIGS. 1, 3 and 4, which as seen above may be regarded as schematically illustrating the anti-fray instrument as a liquid applicator, may also be regarded as schematically illustrating a laser device as the anti-fray instrument. In other words, in such figures the device identified by numeral 18 can also be regarded as a schematic illustration of a laser device. The laser device is controlled by controller 14 based on the programmed information to direct laser energy onto textile 40 to form an anti-fray path 47 along perimeter 44 of area 42.

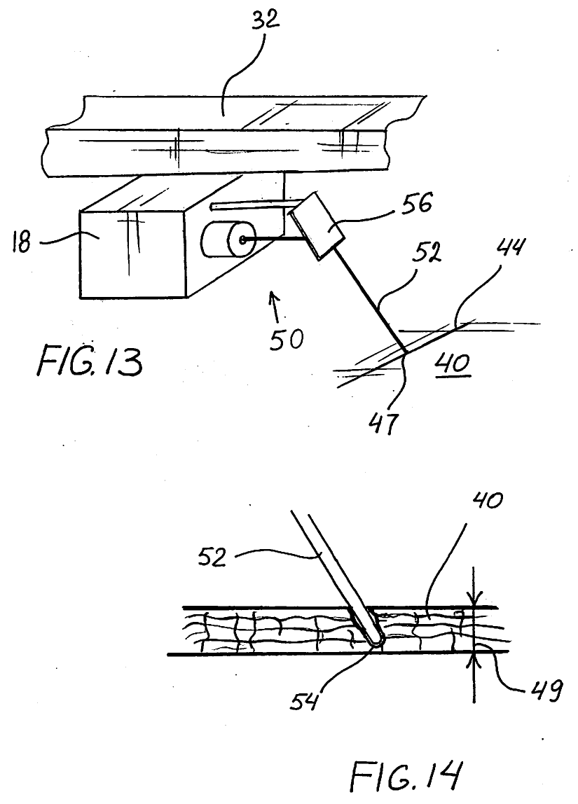

The laser device identified by numeral 18 in FIGS. 1, 3 and 4 when such figures are regarded as showing such embodiment, can be a solid-state laser, which is a preferred form of laser device. An alternative form of laser device is schematically shown in FIG. 13; more specifically, laser device 50 is of the type including a mirror 56.

FIG. 14 schematically illustrates the direction 52 and application of laser energy from the laser device, the laser being set to induce an anti-fray state in less than the full thickness 49 of textile sheet 40, such that the anti-fray-induced portion of textile 40 does not touch textile-receiving surface 12. Thus, FIG. 14 illustrates effective laser penetration to location 54, which is referred to herein for convenience as the focal point.

Precision cutting technology as set forth in various United States and other patents of Mikkelsen Graphic Engineering (MGE) of Lake Geneva, Wis. is applicable to the apparatus and method of this invention. The disclosures of MGE's U.S. Pat. Nos. 6,772,661 (Mikkelsen et al.), U.S. Pat. Nos. 6,619,167 (Mikkelsen et al.), U.S. Pat. Nos. 6,619,168 (Alsten et al.) and U.S. Pat. Nos. 6,672,187 (Alsten et al.), and United States Published Patent Application No. 2004/0083862 (Mikkelsen et al.) are incorporated herein by reference.

In preferred embodiments, the liquid anti-fray composition is a hotmelt composition selected to accommodate the nature of the textile material being cut. A wide variety of hotmelt compositions are available having different physical characteristics and qualities. Suitable hotmelts preferably are applied at a temperature of 150-200° C., have a softening point (Mettler) of 70-130° C. and a medium-fast set rate. They are preferably water-resistant, flexible when set, and stable under variable climate conditions. Preferably, the composition chosen will remain effective even after machine washing of the textiles. Suitable hotmelt materials would be apparent to those skilled in the art who are made familiar with this invention.

Hotmelt compositions typically include a base polymer and a polyolefin. Base polymers may be ethylene vinyl acetate copolymers, polyamides, polyesters, polyurethanes, etc. One highly preferred hotmelt for use in this invention is hotmelt 85000 available from Forbo Adhesives. Such material includes an ethylene vinyl acetate monomer, tackifying resin and paraffin wax. Suitable alternatives for use in various situations would be apparent to those skilled in the art.

Other suitable liquid compositions include air-drying compositions and UV-curing compositions; suitable choices will be apparent to a person skilled in the art who is made familiar with the present invention. When UV-curing or air-drying compositions are used, curing and drying can be facilitated by additional apparatus targeting UV energy or air flow (preferably heated) on the applied composition.

While the cutter shown in the drawings is of the rotary-blade type, other types of cutters are also usable, such as regular tangential drag-blade cutters and oscillating tangential cutters. The preferred rotary-blade cutter is a motor-driven device with a spinning multi-edged round blade. The nature of the cutter is not an essential element of the invention.

While the principles of the invention have been shown and described in connection with specific embodiments, it is to be understood that such embodiments are by way of example and are not limiting.

1. Apparatus for fray-free cutting at the perimeter of an area of a thermoplastic textile sheet, comprising:
a textile-receiving surface;
a controller having programmed information regarding the perimeter of the area;
a laser device configured and arranged to induce an anti-fray state in the textile by application of laser energy as directed by the controller based on the programmed information to form an anti-fray path along the perimeter of the area; and
a cutter movable with respect to the surface as directed by the controller to cut the sheet at the perimeter of the area.

2. The apparatus of claim 1 wherein the laser device is a solid-state laser.

3. The apparatus of claim 1 wherein the laser device includes at least one mirror for directing laser energy onto the textile.

4. The apparatus of claim 1 wherein the laser device is adapted for application of the laser-energy having a focal point set to induce the anti-fray state of the less than the full thickness of the textile sheet, whereby, the anti-fray-induced portion of the textile does not touch the textile-receiving surface.

5. The apparatus of claim 1 wherein the laser device is configured and arranged to apply laser energy onto the textile along the perimeter to be cut.

6. The apparatus of claim 1 wherein the laser device is configured and arranged to apply laser energy onto a blade-cut edge.

7. The apparatus of claim 6 wherein the laser device is carried with the cutter such that the laser device applies laser energy immediately upon cutting.

8. The apparatus of claim 1 wherein:
support structure is secured with respect to the textile-receiving surface; and
the laser device is attached to the support structure for controlled movement along the textile-receiving surface.

9. The apparatus of claim 8 wherein:
the support structure includes a beam spanning the textile-receiving surface and reversibly movable therealong; and
the laser device is reversibly movable along the beam.

10. The apparatus of claim 9 wherein:
the support structure includes a second beam spanning the textile-receiving surface and reversibly movable therealong independently of the other beam; and
the cutter is reversibly movable along the second beam.

11. The apparatus of claim 9 wherein the cutter is attached to the beam and is reversibly movable therealong.

12. The apparatus of claim 8 wherein:
the support structure includes a beam spanning the textile-receiving surface and reversibly movable therealong; and
the laser device and the cutter are movable both with and with respect to the beam in a manner providing independent concurrent movement thereof.

13. The apparatus of claim 1 wherein the textile-receiving surface is substantially horizontal.

14. The apparatus of claim 1 further comprising a vacuum structure adapted to retain the textile sheet in position on the textile-receiving surface.

15. The apparatus of claim 1 wherein:
the programmed information includes information regarding specific graphic characteristics of the textile sheet and information regarding the perimeter of the area relative thereto;
the apparatus further includes a sensor positioned to sense the specific graphic characteristics of the textile sheet; and
the controller is configured to utilize sensed information and the programmed information to compensate for deviations of the sensed from the programmed information of the specific graphic characteristics.

16. The apparatus of claim 15 wherein the specific graphic characteristics and the controller programming are such that the controller compensates for non-uniform distortions of the textile sheet.

17. The apparatus of claim 15 wherein the specific graphic characteristics include registration marks at and/or around the area applied to the textile sheet at the time the perimeter of the area is defined.

18. A method for fray-free cutting at the perimeter of an area of a textile sheet on a textile-receiving surface, comprising:
inducing an anti-fray state in the textile by applying laser energy along the perimeter of the area as directed by a controller based on programmed information; and
cutting the sheet at the perimeter by a cutter movable along the surface as directed by the controller based on the programmed information.

19. The method of claim 18 wherein the laser energy is applied using a laser device movable along the surface as directed by the controller based on programmed information regarding the perimeter.

20. The apparatus of claim 19 wherein the laser device is a solid-state laser.

21. The method of claim 19 wherein the laser device includes at least one mirror for directing laser energy onto the textile to form an anti-fray path along the perimeter of the area.

22. The method of claim 18 wherein the inducing step is such that the application of the laser-energy has a focal point set to induce the anti-fray state of the less than the full thickness of the textile sheet, whereby, after inducement, the anti-fray induced portion of the textile does not touch the textile-receiving surface.

23. The method of claim 18 wherein the inducing step is prior to the cutting step.

24. The method of claim 23 wherein the cutting of the sheet commences while the inducing step is still in progress on the sheet.

25. The method of claim 18 wherein the laser energy is applied onto a blade-cut edge.

26. The method of claim 25 wherein the laser device is carried with the cutter such that the laser device applies laser energy immediately upon cutting.

27. The method of claim 18 wherein the programmed information includes information regarding specific graphic characteristics of the textile sheet and information regarding the perimeter of the area relative thereto and further comprising:
automatically sensing the specific graphic characteristics; and
utilization by the controller of sensed information and the programmed information to compensate for deviations of the sensed from the programmed information of the specific graphic characteristics.

28. The method of claim 27 wherein the specific graphic characteristics and the controller programming are such that the controller compensates for non-uniform distortions of the textile sheet.

29. The method of claim 27 wherein the specific graphic characteristics include registration marks at and/or around the area applied to the textile sheet at the time the perimeter of the area is defined.

30. The method of claim 27 wherein the inducing step is prior to the cutting step.

31. The method of claim 30 wherein the cutting of the sheet commences while the inducing step is still in progress on the sheet.

32. The method of claim 27 wherein the laser energy is applied onto a blade-cut edge.

33. The method of claim 27 wherein the laser device is carried with the cutter such that the laser device applies laser energy immediately upon cutting.
